(19) United States
(12) Patent Application Publication
(10) Pub. No.: US 2026/0236056 A1
(43) Pub. Date: Aug. 13, 2026

(54) PEDAL EMULATOR ASSEMBLY

(71) Applicant: KSR IP Holdings, LLC, Wilmington, DE (US)

(72) Inventors: Matthew Vyskocil, Ridgetown (CA); Amir Jaboukji, West Lorne (CA)

(73) Assignee: KSR IP Holdings, LLC, Wilmington, DE (US)

(21) Appl. No.: 19/536,393

(22) Filed: Feb. 11, 2026

Related U.S. Application Data
(60) Provisional application No. 63/757,102, filed on Feb. 11, 2025.

(51) Int. Cl. G05G 1/38; B60T 7/06; G05G 1/44; G05G 1/50

(52) U.S. Cl. CPC G05G 1/38; B60T 7/06; G05G 1/44; G05G 1/506

(57) ABSTRACT

Embodiments herein are directed to a pedal assembly including a housing, a pedal arm, a first sensor assembly, and a second sensor assembly. The housing includes a first opening surrounded by a first recess portion, and a second opening surrounded by a second recess portion. The pedal arm has a first protrusion to be movably received within the first opening, and a second protrusion to be movably received within the second opening. The first sensor assembly is configured to slidably engage with the first recess portion to retain the first protrusion in the first opening. The second sensor assembly is configured to slidably engage with the second recess portion to retain the second protrusion in the second opening. When a load is applied on the pedal arm, the first protrusion and the second protrusion move, the first sensor assembly and the second sensor assembly independently sense this movement, respectively.

### CROSS-REFERENCE TO RELATED APPLICATIONS

This utility patent application claims priority benefit from U.S. Provisional Patent Application Serial No. 63/757,102, filed February 11, 2025, and entitled “Brake Pedal Emulator”, the entire contents of which is incorporated by reference herein in its entirety.

### TECHNICAL FIELD

The present specification generally relates to pedal assemblies for vehicles and, more specifically, to pedal assemblies with pivot retaining and sensor components.

### BACKGROUND

It is generally known in pedal assemblies to use an integrated pivot pin and sensor components to couple a pedal arm to a housing to permit the pedal arm to pivot about the pivot pin relative to the housing when a load is applied or removed from a pedal pad. Further, it is also known to use spring carrier assembly with multiple components including redundant springs, carrier components, and generally a stem or an elongated member to couple the springs, and carrier components together. As such, the known pedal assemblies require multiple components, have a lengthy assembly process, require multiple processes to assembly, and are complex in assembly and design. Accordingly, there is a need for pedal assembly with a simplified assembly process and design.

### SUMMARY

In one embodiment, a pedal assembly is provided. The pedal assembly includes housing, a pedal arm, a first sensor assembly, and a second sensor assembly. The housing includes a first opening surrounded by a first recess portion, and a second opening surrounded by a second recess portion. The pedal arm has a pedal pad end and an opposite pivot end. A first protrusion extends from one side of the pivot end to be movably received within the first opening, and a second protrusion extending from the opposite side of the pivot end to be movably received within the second opening. The first sensor assembly is configured to slidably engage with the first recess portion to retain the first protrusion in the first opening. The second sensor assembly is configured to slidably engage with the second recess portion to retain the second protrusion in the second opening. When a load is applied on the pedal pad end, the first protrusion moves within the first opening and the second protrusion moves within the second opening, the first sensor assembly and the second sensor assembly independently sense the movement of the first protrusion and the second protrusion, respectively.

In another embodiment, an assembly is provided. The assembly includes housing, a pedal arm, a first sensor assembly, and a second sensor assembly. The housing includes a first opening surrounded by a first recess portion, and a second opening surrounded by a second recess portion. The pedal arm has a pedal pad end and an opposite pivot end, a first protrusion extending from one side of the pivot end to be movably received within the first opening, and a second protrusion extending from the opposite side of the pivot end to be movably received within the second opening. The first sensor assembly is configured to slidably engage with the first recess portion to retain the first protrusion in the first opening. The first sensor assembly includes a target, and a target carrier member configured to retain the target such that the target moves with the first protrusion. The first sensor assembly is configured to sense the movement of the target. The second sensor assembly is configured to slidably engage with the second recess portion to retain the second protrusion in the second opening. The second sensor assembly includes a coupler, and a coupler carrier member coupled to the second protrusion such that the coupler moves with the second protrusion. The second sensor assembly is configured to sense the movement of the coupler. When a load is applied on the pedal pad end, the first protrusion moves within the first opening and the second protrusion moves within the second opening, the first sensor assembly and the second sensor assembly independently sense the movement of the first protrusion and the second protrusion, respectively.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective side view of an example pedal assembly according to one or more embodiments shown and described herein;

FIG. 2 schematically depicts a perspective other side view of the example pedal assembly of FIG. 1 according to one or more embodiments shown and described herein;

FIG. 3 schematically depicts a partially exploded perspective view of the example pedal assembly of FIG. 1 according to one or more embodiments shown and described herein;

FIG. 4A schematically depicts an isolated perspective side view of a housing of the example pedal assembly of FIG. 1, according to one or more embodiments shown and described herein;

FIG. 4B schematically depicts an isolated perspective other side view of the housing of the example pedal assembly of FIG. 1, according to one or more embodiments shown and described herein;

FIG. 4C schematically depicts an isolated plan front view of the housing of the example pedal assembly of FIG. 1, according to one or more embodiments shown and described herein;

FIG. 5A schematically depicts a partially isolated perspective view of the example pedal assembly of FIG. 1 illustrating s sensor system, an emulator assembly, and a pedal arm according to one or more embodiments shown and described herein;

FIG. 5B schematically depicts a partially isolated rear plan view of the example pedal assembly of FIG. 5A according to one or more embodiments shown and described herein;

FIG. 6A schematically depicts an isolated perspective side view of a second sensor assembly of the example pedal assembly of FIG. 1, according to one or more embodiments shown and described herein;

FIG. 6B schematically depicts an isolated perspective other side view of the second sensor assembly of FIG. 6A, according to one or more embodiments shown and described herein;

FIG. 6C schematically depicts an isolated partially exploded side plan view of the second sensor assembly of FIG. 6A, according to one or more embodiments shown and described herein;

FIG. 6D schematically depicts an isolated partially exploded side plan view of a coupler carrier member of the second sensor assembly of FIG. 6C, according to one or more embodiments shown and described herein;

FIG. 7A schematically depicts an isolated perspective side view of a first sensor assembly of the example pedal assembly of FIG. 1, according to one or more embodiments shown and described herein;

FIG. 7B schematically depicts an isolated perspective top view of the first sensor assembly of FIG. 7A, according to one or more embodiments shown and described herein;

FIG. 7C schematically depicts an isolated partially exploded perspective side view of the first sensor assembly of FIG. 7A, according to one or more embodiments shown and described herein;

FIG. 8A schematically depicts an isolated perspective side view of the pedal arm of FIG. 5A, according to one or more embodiments shown and described herein;

FIG. 8B schematically depicts an isolated perspective other side view of the pedal arm of FIG. 8A, according to one or more embodiments shown and described herein; and

FIG. 9 graphically depicts a passive force illustration, according to one more embodiments shown and described herein.

### DETAILED DESCRIPTION

Embodiments described herein are directed to pedal assemblies that utilize an integrated pivot portion extending from a proximate end of a pedal arm, which is received in within a respective opening of the housing and is movably retained to the housing within the respective openings by a sensor system. The sensor system includes a first sensor assembly and a second sensor assembly. The first sensor assembly is configured to slidably engage with a first recess portion of the housing to retain the first protrusion in the respective first opening. The second sensor assembly is configured to slidably engage with a second recess portion of the housing to retain the second protrusion in the respective second opening. When a load is applied onto a pedal pad end of the pedal arm, the first protrusion moves within the first opening and the second protrusion moves within the second opening and each of the first sensor assembly and the second sensor assembly independently sense the movement of the first protrusion and the second protrusion respectively in a redundant manner.

The pedal assemblies further include an emulator assembly configured to provide a force feedback to a driver’s foot since the pedal assemblies are not connected to a conventional hydraulic system. Accordingly, this arrangement permits for a less complicated and more compact pedal assembly compared to conventional pedal assemblies. Further, the sensor system provided herein may have better correlation because of reduced mechanical losses between the pivot pins and the sensors for measuring the movement of the protrusions. There are also fewer possible failure modes that could result in total loss of sensing. Additionally, embodiments described herein are directed to one of the pair of sensing assemblies to utilize inductive sensing technology while the other one of the pair of sensing assemblies utilize Hall Effect sensing technologies.

As used herein, the term “communicatively coupled” means that coupled components are capable of exchanging data signals with one another such as, for example, electrical signals via conductive medium or a non-conductive medium, though networks such as via Wi-Fi, Bluetooth, and the like, electromagnetic signals via air, optical signals via optical waveguides, and the like.

As used herein, the term “proximal” or “first end” means closer to or in the direction of an origin of an element, such as a link member. The term “distal” or “second end” means further from the origin of the element. Put another way, the terms “distal” or “second end” mean opposite to the proximal end or first end of an element.

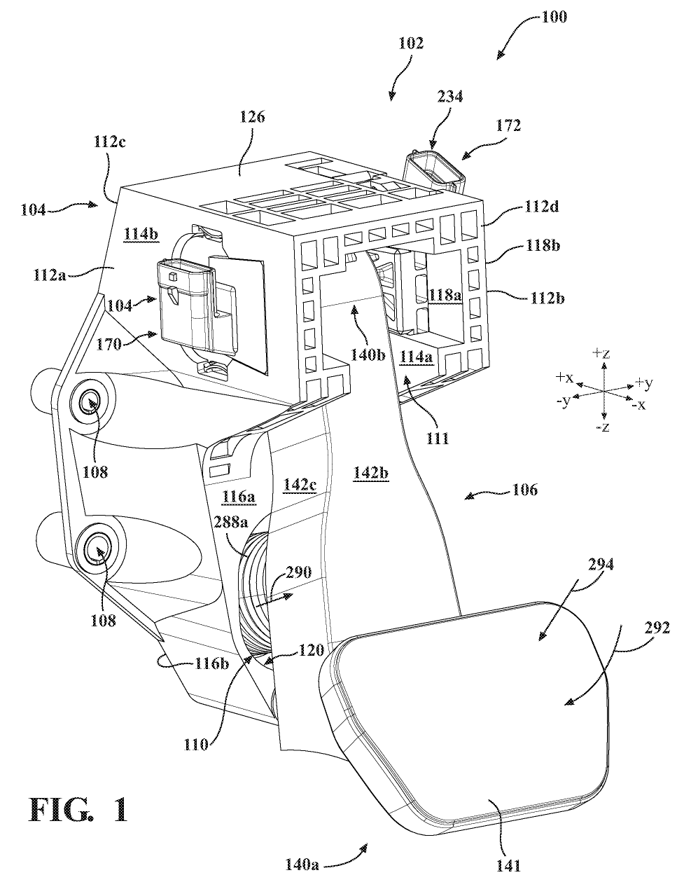

As used herein, the term “assembly lateral direction” refers to the cross-direction of the system (i.e., in a +/- Y direction of the coordinate axes depicted in FIG. 1). The term “assembly longitudinal direction” refers to the forward-rearward direction (i.e., along the +/- X axis of the coordinate axes depicted in FIG. 1), and is transverse to the lateral direction. The term “assembly vertical direction” refers to the upward-downward direction of the system (i.e., in the +/- Z direction of the coordinate axes depicted in FIG. 1).

Now referring to FIGS. 1-3, an example pedal assembly 100 is schematically depicted. The pedal assembly 100 may include a sensor system 102, a housing 104, and a pedal arm 106. The housing 104 may be configured to removably mount to an external surface or other vehicle components, such as, but not limited, to an instrument panel (IP), a firewall, and/or the like. The housing 104 may be configured to mount to the external surface through a plurality of mounting apertures 108, each of the plurality of mounting apertures 108 sized to receive at least one fastener. For example, and without limitation, each of the plurality of mounting apertures 108 may receive a screw, rivet, bolt, adhesive, weld, hook and loop, and/or the like.

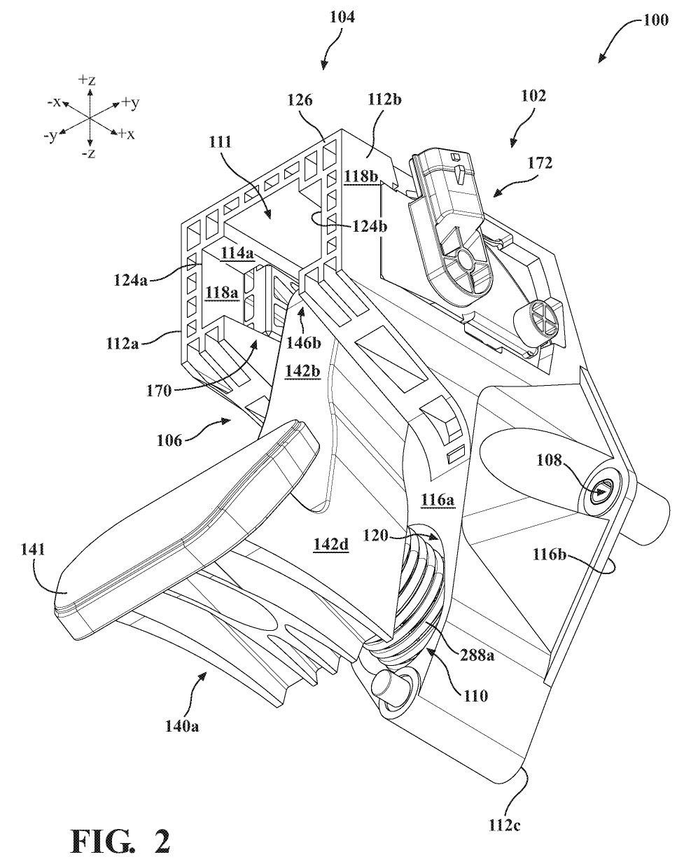

The example pedal assembly 100 may further include an emulator assembly 110 (FIG. 2) positioned within a cavity 112 of the housing 104 and extending between the pedal arm 106 and the housing 104, as best illustrated in FIGS. 1 and 2.

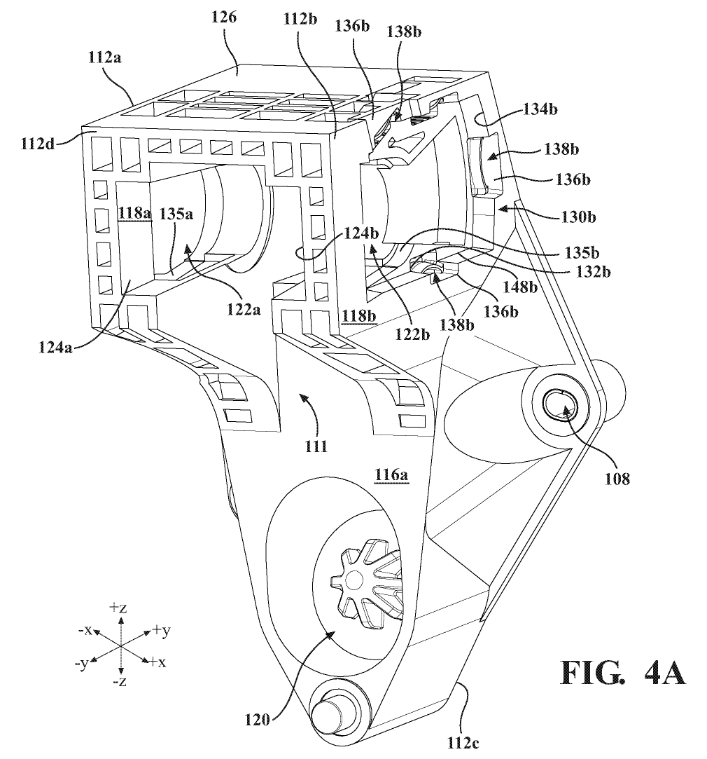

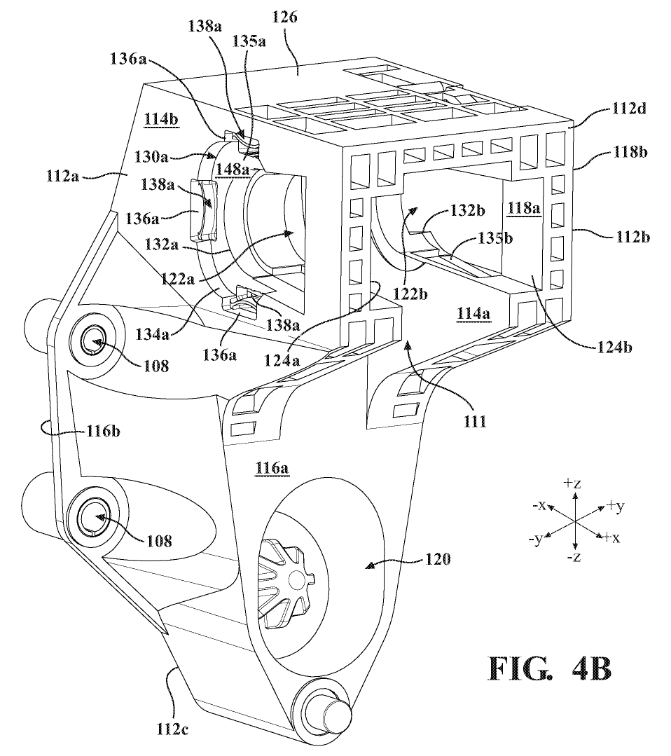

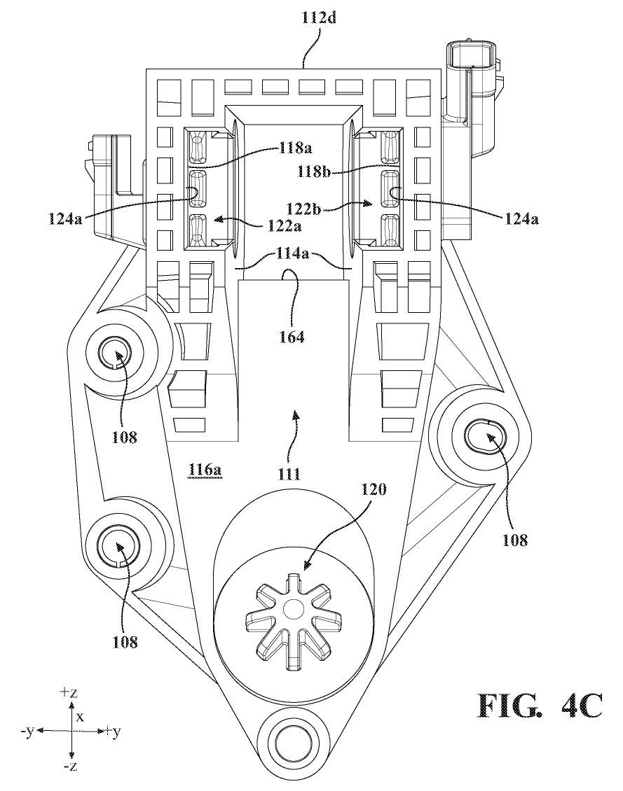

Now referring to FIGS. 1-5B, the cavity 111 of the housing 104 may be defined by a pair of sidewalls 112a, 112b that have an inner surface 114a and an opposite outer surface 114b, a rear wall 112c that has an interior surface 116a and an opposite exterior surface 116b, and a front wall 112d that has an interior surface 118a and an opposite exterior surface 118b. In some embodiments, a receiving cavity 120 extends inward from the interior surface 116a of the rear wall 112c in a direction towards the exterior surface 116b of the rear wall 112c to provide receiving portion in the rear wall 112c of the housing 104 to receive one end of the emulator assembly 110, as discussed in greater detail herein.

Each of the pair of sidewalls 112a, 112b include an opening 122a, 122b, respectively, that extend in the assembly lateral direction (e.g., in the +/- Y direction) between the interior surface 118a and the exterior surface 118b of the respective sidewall 112a, 112b, to open into the cavity 111 of the housing 104. Further, the interior surface 118a of the respective sidewall 112a, 112b may include a receiving groove 124a, 124b extending the assembly longitudinal direction (e.g., in the +/- X direction) to intersect with the respective opening 122a, 122b of the housing 104. Each of the openings 122a, 122b and each of the receiving grooves 124a, 124b, are covered by a top wall 126 of the housing that includes or is defined by portions of the interior surface 118a. Each of the receiving grooves 124a, 124b may receive portions of the sensor assembly 170, 172 respectively, and portions of the pedal arm protrusions 144a, 144b respectively, as discussed in greater detail herein.

The sidewall 112a may include a first recess portion 130a embedded within the outer surface 114b and may be positioned to partially or fully circumferentially surround the opening 122a. The sidewall 112b may include a second recess portion 130b embedded within the outer surface 114b and may be positioned to partially or fully circumferentially surround the opening 122b. The first recess portion 130a and the second recess portion 130b may each be sized and shaped to receive different portions of the sensor system 102, as discussed in greater detail herein.

The first recess portion 130a may include one or more step portions 132a (e.g., portions of different heights in the assembly lateral direction (e.g., in the +/- Y direction) to terminate at a terminating surface 135a of the first recess portion 130a. Further, an outer perimeter 134a may include at least one cutout portion 136a and corresponding receiving slot 138a that are configured to receive positions of the sensor system 102 to removably couple portions of the sensor system 102 to the housing 104 within the first recess portion 130a, as discussed in greater detail herein.

The second recess portion 130b may include step portions 132b (e.g., portions of different heights in the assembly lateral direction (e.g., in the +/- Y direction) to terminate at a terminating surface 135b of the second recess portion 130b. Further, an outer perimeter 134b defined by the recess may include at least one cutout portion 136b and corresponding receiving slot 138b that are configured to receive positions of the sensor system 102 to removably couple portions of the sensor system 102 to the housing 104 within the second recess portion 130b, as discussed in greater detail herein.

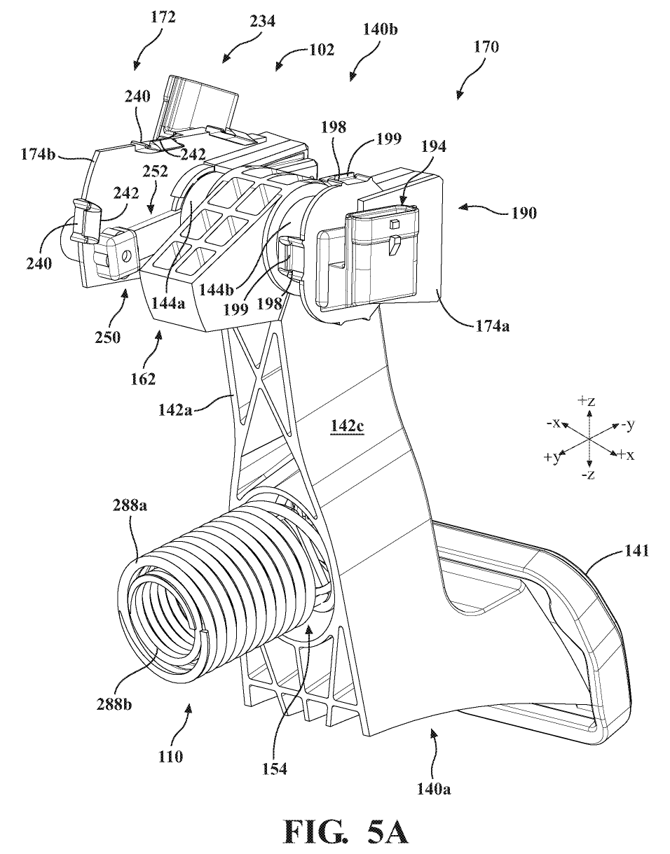

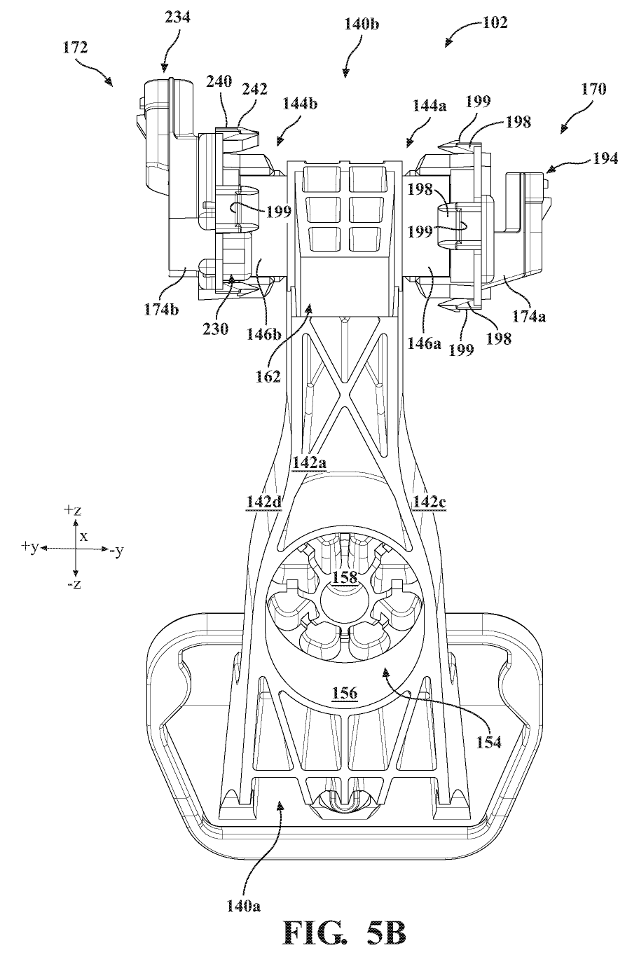

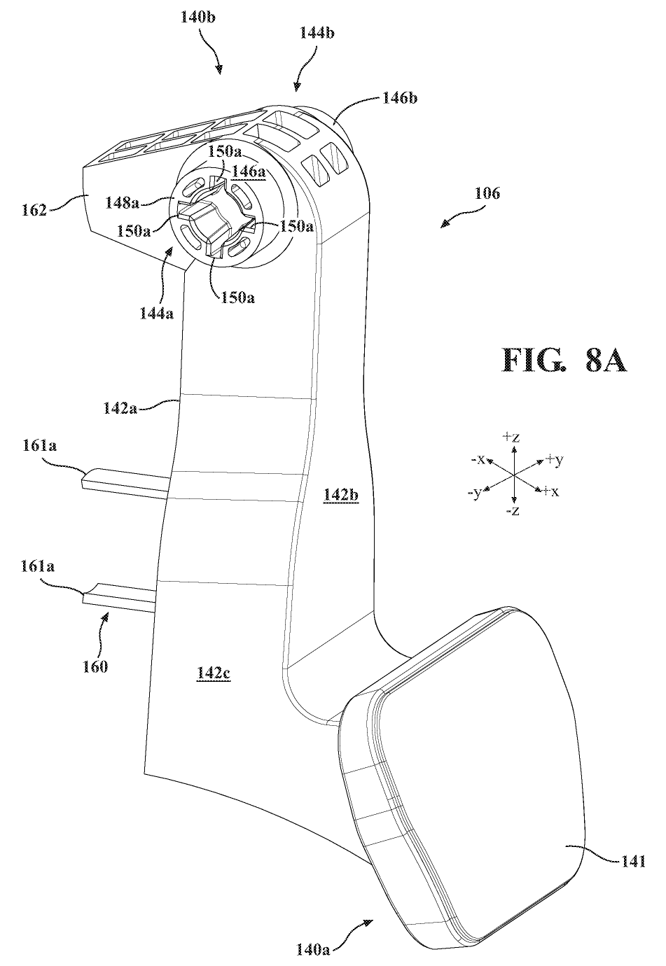

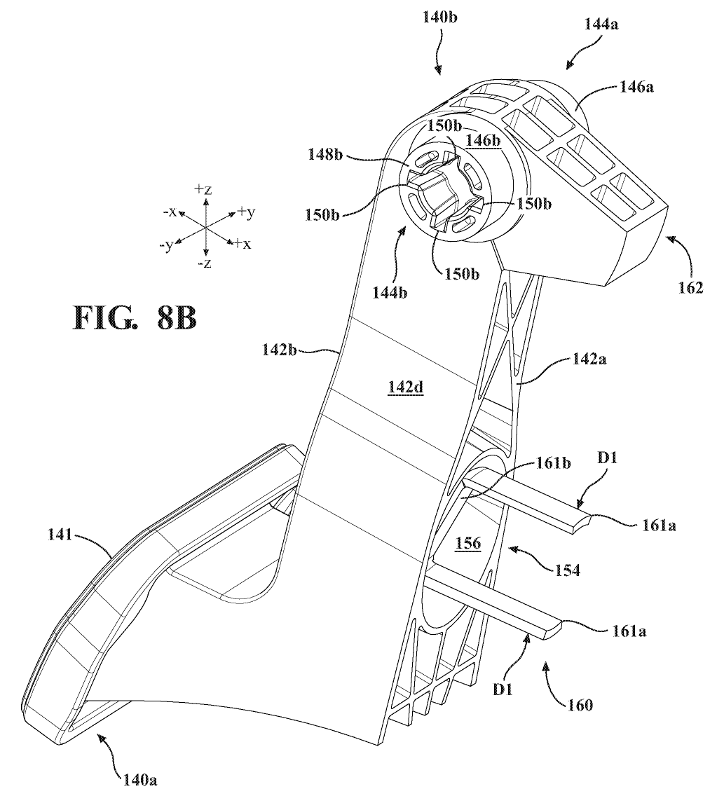

Still referring to FIGS. 1-3 and now also to FIGS. 5A-5B and 8A-8B, the pedal arm 106 may include a pedal pad end 140a and an opposite pivot end 140b. Further, the pedal arm 106 may be a monolithic structure that includes an innermost surface 142a and an opposite outermost surface 142b that is spaced apart by a pair of side surfaces 142c, 142d to define a thickness of the pedal arm 106. The pedal pad end 140a may be configured to receive a pedal pad 141.

The pivot end 140b of the pedal arm 106 may include a pair of pair of protrusions 144a, 144b. One protrusion 144a extends from one side surface 142c of the pedal arm 106 and the other protrusion 144b extends from the other one side surface 142d of the pedal arm 106. As such, each of the protrusions 144a, 144b extend perpendicular to the innermost surface 142a and the outermost surface 142b of the pedal arm 106, such as in the assembly lateral direction (e.g., in the +/- Y direction). This is non-limiting and the protrusions 144a, 144b may extend in any direction, at any angle, and not necessarily perpendicular to the innermost surface 142a and the outermost surface 142b of the pedal arm 106.

Each of the protrusions 144a, 144b may be tubular or cylindrical in shape, and include an outer surface 146a, 146b, respectively, although other shapes are contemplated. For example, and without limitation, frusto-variations thereof, elliptical, hexagonal, octagonal, and/or the like are contemplated. Each of the protrusions 144a, 144b may also include terminating surfaces 148a, 148b, respectively, that when received within the cavity 112, are each received in the openings 122a, 122b, respectively, to face the terminating surface 135a, 135b of the first recess portion 130a and the second recess portion 130b, respectively, as discussed in greater detail herein.

Further, a plurality of spaced apart receiving elongated slot members 150a, 150b, extend inward from the terminating surfaces 135a, 135b, towards the side surfaces 142c, 142d in the assembly lateral direction (i.e., in the +/-Y direction). Each of the receiving elongated slot members 150a, 150b of the protrusions 144a, 144b receive and couple to components of the sensor system 102, as discussed in greater detail herein.

Still referring to FIGS. 1-3, 5A-5B and 8A-8B, embedded in the innermost surface 142a and positioned between the pedal pad end 140a and the opposite pivot end 140b is a pedal arm receiving cavity 154. The pedal arm receiving cavity 154 extends in the direction from the innermost surface 142a towards the surface 142b. The innermost surface 142a may define the pedal arm receiving cavity 154 as a continuous wall surface 156 terminating at a terminating surface 158. The terminating surface 158 may be configured to sized and shaped to receive a portion of the emulator assembly 110, as discussed in greater detail herein.

The pedal arm 106 may further include an elongated portion 162 that is curvilinear or arcuate in shape and extending from the pivot end 140b. In some embodiments, the elongated portion 162 may be received within a recess 164 of the cavity 111 defined by the interior surface 118a of the housing 104 such that the elongated portion 162 may curve or bend through and within the recess 164. As such, a length and/or angle of the elongated portion 162 as well as the size and shape of the recess 164 may set a maximum and a minimum arc of travel of the pedal arm 106. That is, the elongated portion 162 may contact a surface of the recess 164 at the home position (minimum arc of travel) and with a different portion of the surface of the recess 164 (at the maximum arc of travel). In some embodiments, the elongated portion 162 may be a monolithic structure formed as a single structure with the pedal arm 106. In other embodiments, the elongated portion 162 may be coupled or otherwise attached to the pivot end 140b of the pedal arm 106 via at least one fastener. Example fasteners include, without limitation, bolt and nut, screw, rivet, weld, adhesive, epoxy, and/or the like.

The protrusions 144a, 144b, as well as any of the other portions or components of the protrusions 144a, 144b and/or components of the pedal arm 106 may be integrated with one another, i.e., may be a single monolithic structure that is formed together, such as by using injection molding techniques, additive manufacturing, and/or the like.

As used herein, “additive manufacturing” refers generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt base superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

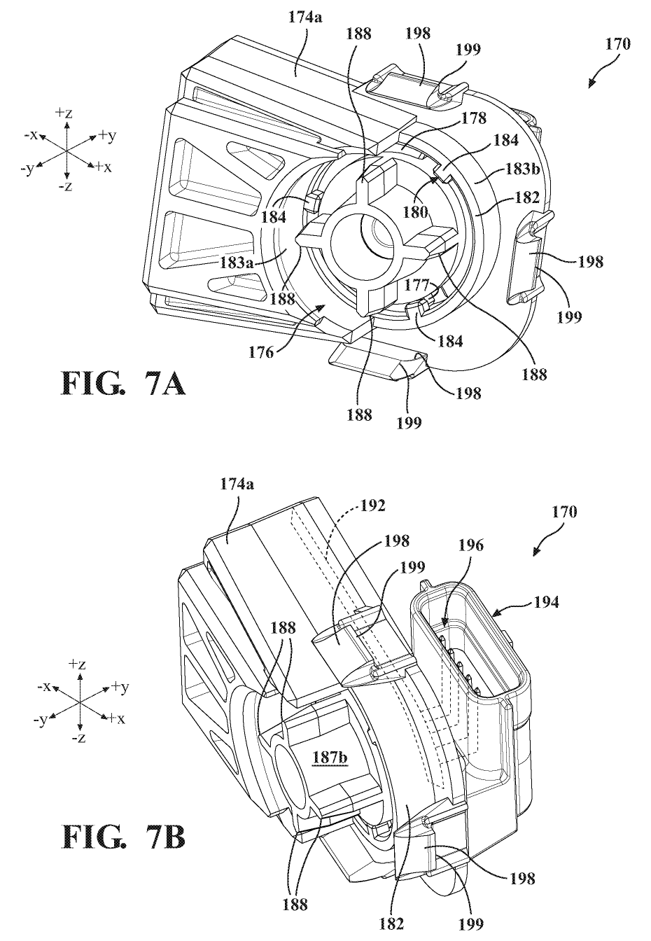

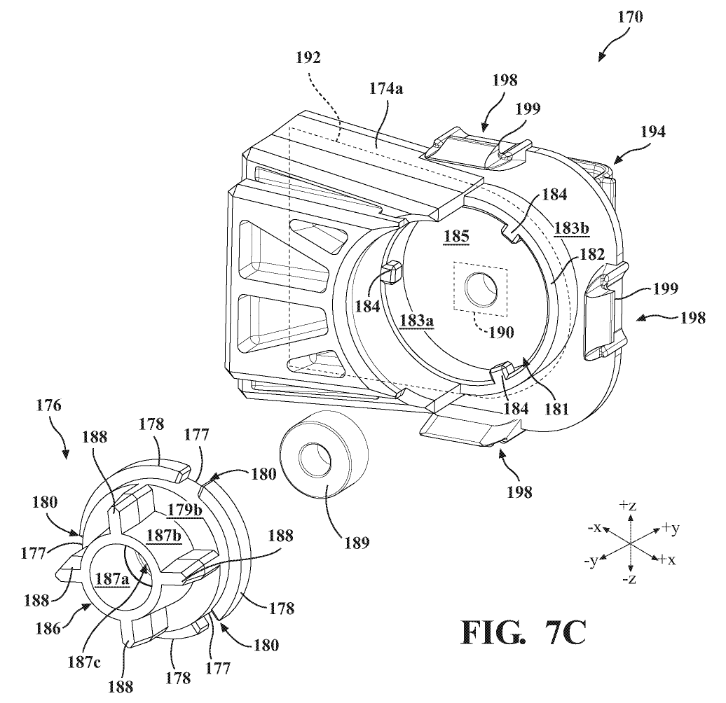

Now referring to FIGS. 1-3, 5A-5B, 6A-6D and 7A-7C, the sensor system 102 may include a first sensor assembly 170 and a second sensor assembly 172. Each of the first sensor assembly 170 and the second sensor assembly 172 include a sensor housing 174a, 174b, respectively, and are each configured to be received within, movable coupled to, and/or slidably engage with the corresponding first recess portion 130a or the second recess portion 130b, as discussed in greater detail herein.

Now referring to FIGS. 1-3, 5A-5B and 7A-7C, the first sensor assembly 170 may include a target carrier member 176 that is configured to be coupled to the corresponding protrusion 144a of the pedal arm 106, as discussed in greater detail herein. The target carrier member 176 includes an outer surface portion 178 extending form an outer peripheral surface 177, an inner surface 179a, and an opposite outer surface 179b. The outer surface portion 178 may include at least one receiving notch 180. The at least one receiving notch 180 may be a gap that spaces apart adjacent outer surface portions 178 to provide access to the outer peripheral surface 177 in the gap. The sensor housing 174a has a receiving cavity 181 defined by a continuous or partially continuous wall 182 and an interior surface 185. The continuous or partially continuous wall 182 is sized and shaped to receive portions of the target carrier member 176 such that the outer surface portion 178 may abut or may make contact with an inner surface 183a, opposite of an outer surface 183b of the continuous or partially continuous wall 182 and such that the interior surface 185 and inner surface 179a may abut or otherwise may make contact. Further, extending from the inner surface 183a of the continuous or partially continuous wall 182 is at least one protrusion 184. The at least one protrusion 184 may be configured to be received by a corresponding one of the at least one receiving notch 180 when the target carrier member 176 is coupled to the sensor housing 174a to align the outer surface portions 178 during installation.

Said another way, during installation, the at least one protrusion 184 aligns with the corresponding at least one receiving notch 180 to permit for the target carrier member 176 installation to the sensor housing 174a. Once installed, the at least one protrusion 184 and the corresponding at least one receiving notch 180 may not interact with each other once the target carrier member 176 has been coupled to the sensor housing 174a.

Example coupling include, without limitation, push and twist lock, snap fit, and the like. As such, in the depicted embodiment, there are three of the at least one protrusions 184 that are received within each of the at least one receiving notches 180 that are used as keys to couple the target carrier member 176 to the sensor housing 174a to retain portions of the first sensor assembly 170 to the sensor housing 174a while permitting portions or all of the target carrier member 176 to move or rotate relative to the sensor housing 174a and/or, in other embodiments, relative to the outer surface portions 178 of the target carrier member 176.

Further, extending from the outer surface 179b of the target carrier member 176 is a continuous wall member 186 that includes an interior surface 187a and an opposite exterior surface 187b and defines an aperture 187c therethrough. A plurality of elongated members 188 extend generally or substantially radially outward from the exterior surface 187b. Each of the plurality of elongated members 188 may be tapered or sloped and are each configured to be received in a corresponding receiving elongated slot members 150a of the protrusion 144a of the pedal arm 106.

A target 189 is positioned within the aperture 187c and may be at least partially retained by the interior surface 187a of the continuous wall member 186 such that the target 189 moves along with movement of the target carrier member 176 and the movement of first protrusion 144a. That is, because the target carrier member 176 is coupled to the first protrusion 144a via the plurality of elongated members 188 received in the corresponding receiving elongated slot members 150a of the protrusion 144a, when the protrusion 144a moves, portions of the target carrier member 176 and the target 189 may also move in a synchronous manner such that at least portions of the target carrier member 176 move or rotate within the receiving cavity 181 of the sensor housing 174a with respect to the sensor housing 174a. The movement of the target 189 is captured by a sensor 190 of the first sensor assembly 170.

It should be appreciated that in other embodiments, the target carrier member 176 includes the corresponding receiving elongated slot members 150a and the first protrusion 144a includes the plurality of elongated members 188 that received in the corresponding receiving elongated slot members 150a of the target carrier member 176 such that when the protrusion 144a moves, portions of the target carrier member 176 and the target 189 may also move in a synchronous manner such that at least portions of the target carrier member 176 move or rotate within the receiving cavity 181 of the sensor housing 174a with respect to the sensor housing 174a. The movement of the target 189 is captured by the sensor 190 of the first sensor assembly 170.

That is, when the first sensor assembly 170 is installed onto the housing 104, the target 189 may be co-axially aligned with the sensor 190, the target carrier member 176, the opening 122a, and the terminating surface 148a of the first protrusion 144a and the sensor 190 may be configured to measure movement of the protrusions 144a of the pedal arm 106, as described in further detail herein.

In the depicted embodiment, the first sensor assembly 170 may be a Hall Effect type sensor. Optionally, the first sensor assembly 170 may include a printed wiring assembly 192 and a connector housing 194 extending from an outer surface of the sensor housing 174a. The printed wiring assembly 192 may include a circuit board (or a printed circuit board), which may include at least one Hall Effect chip as the sensor 190 and a plurality of terminal pins 196 extending therefrom.

The first sensor assembly 170 utilizes Hall Effect sensing technologies to detect movement of the target 189. The sensor 190 is configured to be sensitive to a Hall effect detection of magnetic change, and to convert a displacement or angular measurement of the target 189, which may be a magnet, to an electronic or electromagnetic signal indicative of a position or movement of the first protrusion 144a. This information is transmitted through the plurality of terminal pins 196 positioned within the connector housing 194 and to the vehicle side electronic control unit and/or the powertrain controller for processing. The target 189, depicted as a magnet, may be sized and shaped to be positioned within the aperture 187c is installed into the sensor housing 174a in a positioned that is predetermined and is near or adjacent to the protrusion 144a and adjacent to the sensor 190. In some embodiments, the target 189 may be generally circular. In other embodiments, the target 189 may be a plurality of other shapes, such as rectangular, square, hexagonal, octagonal, and/or the like. The target 189 may move dependent on the pressure applied to the pedal pad 141 of the pedal arm 106, as discussed in greater detail herein.

In some embodiments, portions of the sensor housing 174a of the first sensor assembly 170 may be formed from an overmolded, additive manufacturing, injection molding techniques, and/or the like, to encapsulate and protect portions or all of the one or more sensor components and may be used to couple the first sensor assembly 170 to the first recess portion 130a of the housing 104. That is, the sensor housing 174a may further include a plurality of resilient members 198 that include a tab member 199 on a distal end that are configured to be inserted into the corresponding at least one cutout portion 136a and corresponding receiving slot 138a to couple or otherwise attach, such as in a snap fit arrangement, the first sensor assembly 170 to the housing 104 at the first recess portion 130a. In other embodiments, the first sensor assembly 170 is coupled to the first recess portion 130a via at least one fastener, such as, without limitation, a screw, bolt and nut, rivet, adhesive, weld, epoxy, hook and loop, and/or the like.

In other embodiments, the sensor housing 174a may further include the at least one cutout portion 136b and the corresponding receiving slot 138b and the housing 104 may include the plurality of resilient members 198 that include the tab member 199 on the distal end that are configured to be inserted into the corresponding at least one cutout portion 136b and corresponding receiving slot 138b to couple or otherwise attach, such as in a snap fit arrangement, the sensor assembly 170 to the housing 104 at the first recess portion 130a.

Now referring to Now referring to FIGS. 1-3, 5A-5B and 6A-6D, the second sensor assembly 172 may include a coupler carrier member 200 that includes a carrier retaining portion 201 configured to be coupled to the corresponding protrusion 144b of the pedal arm 106, as discussed in greater detail herein. The carrier retaining portion 201 includes an outer surface portion 202 extending form an outer peripheral surface 204, an inner surface 206a, and an opposite outer surface 206b. The outer surface portion 202 may include at least one receiving notch 208. The at least one receiving notch 208 may be a gap that spaces apart adjacent outer surface portions 202 to provide access to the outer peripheral surface 204 in the gap. The sensor housing 174b has a receiving cavity 210 defined by a partially continuous wall 212 and an interior surface 214. The partially continuous wall 212 is sized and shaped to receive the carrier retaining portion 201 such that the outer surface portion 202 may abut or may make contact with an inner surface 216a opposite of an outer surface 216b of the partially continuous wall 212 and such that the interior surface 214 and inner surface 206a may abut or otherwise may make contact. Further, extending from the inner surface 216a of the partially continuous wall 212 is at least one protrusion 218. The at least one protrusion 218 is configured to be received by a corresponding one of the at least one receiving notch 208 when the carrier retaining portion 201 is coupled to the sensor housing 174b to align the carrier retaining portion 201 and the sensor housing 174b during installation.

Said another way, during installation, the at least one protrusion 218 aligns with the corresponding at least one receiving notch 208 to permit for the coupler carrier member 200 installation to the sensor housing 174b. Once installed, at least one protrusion 218 and the corresponding at least one receiving notch 208 may not interact with each other once the coupler carrier member 200 has been coupled to the sensor housing 174b.

Example coupling include, without limitation, push and twist lock, snap fit, and the like. As such, in the depicted embodiment, there are three at least one protrusions 218 that are received within three of the at least one receiving notches 208 that are used as keys to couple the outer surface portions 202 of the carrier retaining portion 201 to the sensor housing 174b to retain portions or all of the coupler carrier member 200 to the sensor housing 174b while permitting portions or all of the coupler carrier member 200 to move or rotate relative to the sensor housing 174b and/or in other embodiments, relative to the outer surface portions 202 of the carrier retaining portion 201.

Further, extending from the outer surface 206b of the carrier retaining portion 201 is a continuous wall member 220 that includes an interior surface 222a and an opposite exterior surface 222b and defines an aperture 222c therethrough. A plurality of elongated members 224 extend radially outward from the exterior surface 222b. Each of the plurality of elongated members 224 may be tapered or sloped and are each configured to be received in a corresponding receiving elongated slot members 150b of the protrusion 144b of the pedal arm 106. The inner surface 206a may include a coupler cut-out recess 226 that is sized and shape to a coupler 228. As such, the coupler cut-out recess 226 may be configured to at least partially retain the coupler 228 to the carrier retaining portion 201 such that the coupler 228 moves along with movement of the carrier retaining portion 201 and the movement of second protrusion 144b. That is, because the carrier retaining portion 201 is coupled to the second protrusion 144b via the plurality of elongated members 224 received in the corresponding receiving elongated slot members 150b of the second protrusion 144b, when the second protrusion 144b moves, portions of the coupler carrier member 200 and the coupler 228 also move in a synchronous manner such that at least portions of the coupler carrier member 200 move or rotate within the receiving cavity 210 of the sensor housing 174b with respect to the sensor housing 174b. The movement of the coupler 228 is captured by a sensor assembly 230 of the second sensor assembly 172, as discussed in greater detail herein.

It should be appreciated that in other embodiments, the coupler carrier member 200 includes the corresponding receiving elongated slot members 150b and the second protrusion 144b includes the plurality of elongated members 224 that received in the corresponding receiving elongated slot members 150b of the coupler carrier member 200 such that when the second protrusion 144b moves, portions of the coupler carrier member 200 and the coupler 228 may also move in a synchronous manner such that at least portions of the coupler carrier member 200 move or rotate within the receiving cavity 210 of the sensor housing 174b with respect to the sensor housing 174b. The movement of the coupler 228, 189 is captured by the sensor assembly 230 of the second sensor assembly 172.

That is, when the second sensor assembly 172 is installed onto the housing 104, the coupler 228 may be co-axially aligned with the sensor assembly 230, the carrier retaining portion 201, the opening 122b, and the terminating surface 148b of the second protrusion 144b and the sensor assembly 230 may be configured to measure movement of the second protrusion 144b of the pedal arm 106, as described in further detail herein.

In the depicted embodiment, the second sensor assembly 172 may be an inductive type sensor such that the sensor assembly 230 may include a printed wiring assembly 232 and a connector housing 234. The printed wiring assembly 232 may include a circuit board (or a printed circuit board), which may include at least one receiver coil 235, a transmitter coil 236, and a plurality of terminal pins 238 extending therefrom.

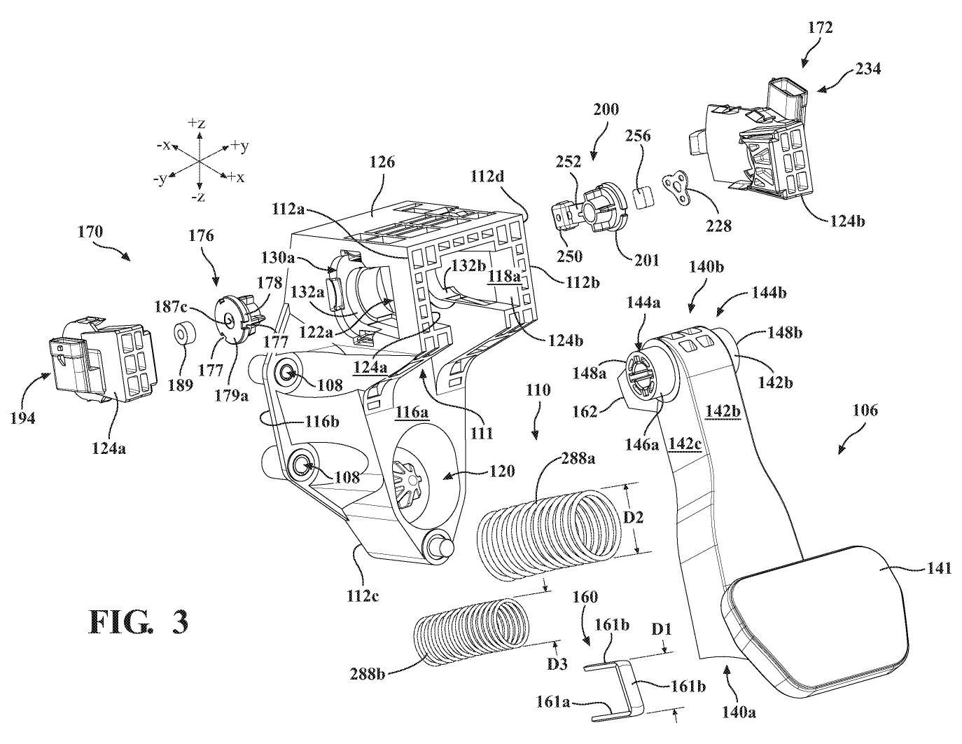

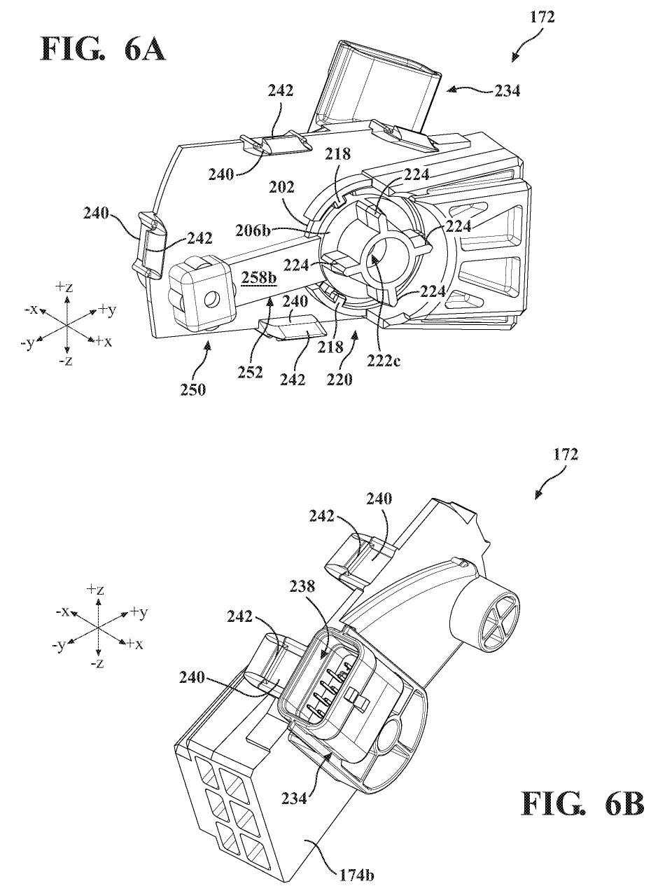

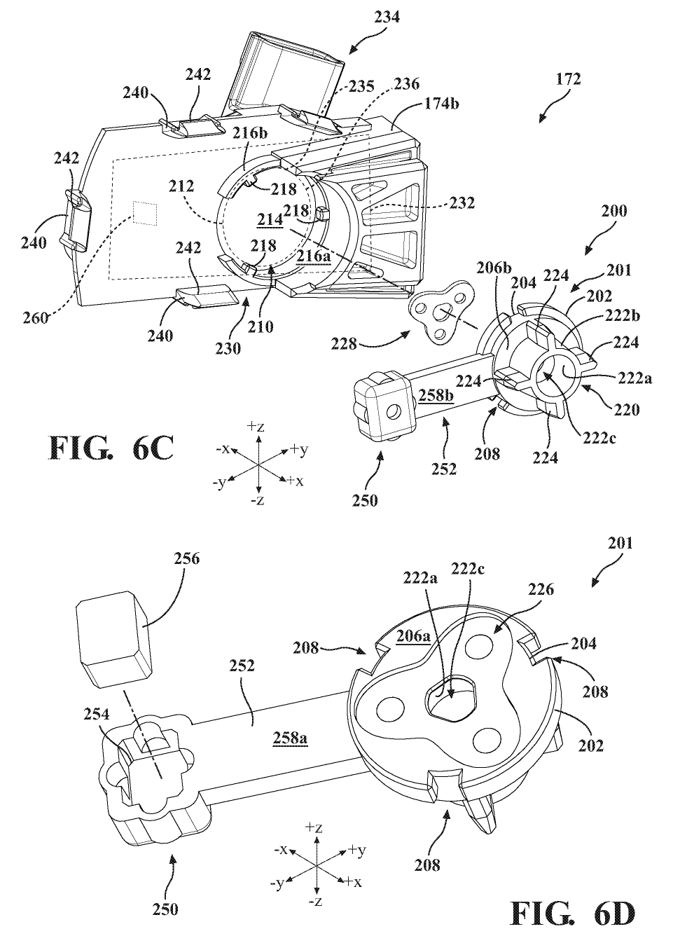

In the assembled state, the coupler 228 may be positioned adjacent to the at least one receiver coil 235 by the carrier retaining portion 201. In some embodiments, the coupler 228 may include distinct lobes, such as three lobes as illustrated in FIGS. 3 and 6C. This is non-limiting and the coupler 228 may have more or less lobes, be circular, or other shapes, such as a half-moon, square, rectangular, and/or the like. The coupler 228 may move dependent on the load applied to the pedal pad 141 of the pedal arm 106, as discussed in greater detail herein.

The at least one receiver coil 235 and the transmitter coil 236 work in tandem such that the at least one receiver coil 235 detects movements of the coupler 228 which is then transmitted via the plurality of terminal pins 238 through a vehicle side contactor communicatively coupled to the plurality of terminal pins 238 positioned within the connector housing to a vehicle side electronic control unit and/or powertrain controller. As such, using inductive principles, an angular measurement of the coupler 228 may be converted into an electronic or electromagnetic signal indicative of a position or movement of the second protrusion 144b.

In the depicted embodiment, the coupler carrier member 200 may optionally include a wake-up target portion 250 spaced apart from the carrier retaining portion 201 by an elongated arm portion 252. The wake-up target portion may include a cavity 254 that is configured to receive a second target 256. The cavity may extend from an inner surface 258a, opposite of an outer surface 258b of the elongated arm portion 252. As such, the wake-up target portion 250 may be positioned at a distal end of the elongated arm portion 252 while the carrier retaining portion 201 is positioned at a proximate end of the elongated arm portion 252. In some embodiments, the wake-up target portion 250, the carrier retaining portion 201, and the elongated arm portion 252 are formed as a single monolithic structure. In other embodiments, each of these may be formed together or coupled to one another by a fastener. Example fasteners include, without limitation, weld, adhesive, epoxy, screw, nut and bolt, rivet, hook and loop, and/or the like.

The second target 256 positioned within the cavity 254 of the wake-up target portion 250 is configured to move when the coupler carrier member 200 is moved or rotated based on the load applied to the pedal pad 141. The printed wiring assembly 232 may further include a second sensor 260 that is configured to sense movement of the second target 256. The second sensor 260 may be positioned adjacent or co-axially with the second target 256 when the second target 256 is in the home position (e.g., no load on the pedal pad 141 FIG. 1). As such, any load applied to the pedal pad 141 (FIG. 1) would move the second target 256, thereby changing a magnetic field strength at the second sensor 260, indicative of movement of the pedal arm 106.

The second target 256 may be magnet with a plurality of shapes, such as rectangular, square, hexagonal, octagonal, and/or the like. The second sensor 260 may be at least one Hall effect chip that is sensitive to a Hall effect detection of magnetic change. As such, the second sensor 260 may be an angular sensor that senses angular movement of the second target 256 by sensing changes in the in-plane magnetic field components. Further, the second sensor 260 may act as a switch that is configured to detect the magnetic field strength generated by the second target 256 that when there is a change in the magnetic field (e.g., either when the change exceeds a predetermined amount or when the magnetic strength does not meet a predetermined amount), the second sensor 260 may be a device that is configured to either initiate a first signal to a vehicle side electronic control unit or inhibits (e.g., stops) the transmitting of a second signal to the vehicle side electronic control unit. The receiving of the first signal or the stopping of the second signal is an indication to the vehicle side electronic control unit to wake-up other electronics that are switched from a powered off state now into a powered on state, for electrical savings, due to movement or based on movement of the second target 256.

In some embodiments, portions of the sensor housing 174b of the second sensor assembly 172 may be formed from an overmolded, additive manufacturing, injection molding techniques, and/or the like, to encapsulate portions or all of the one or more sensor components and may be used to couple the second sensor assembly 172 to the second recess portion 130b of the housing 104. That is, the sensor housing 174b may further include a plurality of resilient members 240 that include a tab member 242 on a distal end that are configured to be inserted into the corresponding at least one cutout portion 136b and corresponding receiving slot 138b to couple or otherwise attach, such as in a snap fit arrangement, the second sensor assembly 172 to the housing 104 at the second recess portion 130b. In other embodiments, the second sensor assembly 172 is coupled to the first recess portion 130a via at least one fastener, such as, without limitation, a screw, bolt and nut, rivet, adhesive, weld, epoxy, hook and loop, and/or the like.

In other embodiments, the sensor housing 174b may further include the at least one cutout portion 136b and the corresponding receiving slot 138b and the housing 104 may include the plurality of resilient members 240 that include the tab member 242 on the distal end that are configured to be inserted into the corresponding at least one cutout portion 136b and corresponding receiving slot 138b to couple or otherwise attach, such as in a snap fit arrangement, the second sensor assembly 172 to the housing 104 at the second recess portion 130b.

It should be understood that the first sensor assembly 170 and the second sensor assembly 172 utilize different sensing technologies to simultaneously measure the movement of the pivot end 140b of the pedal arm 106 such that redundant sensing via the two different sensing technologies may occur. Further, because the redundant sensing described herein uses different sensing techniques, such an arrangement provides for a more robust redundant sensing compared to conventional systems.

Referring back to FIGS. 1-3 and 5A-5B, in an assembled state, the protrusions 144a, 144b are movably received in the openings 122a, 122b and coupled to the first sensor assembly 170 and the second sensor assembly 172, respectively, which are coupled to the first recess portion 130a and the second recess portion 130b, respectively, such that portions of the first sensor assembly 170 and the second sensor assembly 172 may oppose the terminating surfaces 148a, 148b of the protrusions 144a, 144b, respectively, movement of the protrusions 144a, 144b may be accurately detected. That is, the coupler 228, the transmitter coil 236, the at least one receiver coil 235, the carrier retaining portion 201, and the protrusion 144b may be coaxially aligned. Further, the target 189, the sensor 190, the target carrier member 176, and the protrusion 144a may be coaxially aligned.

In operation, a force, depicted by arrow 294 in FIG. 1, applied on the pedal pad end 140a may operate to move the first protrusion 144a within the first opening 122a and the second protrusion 144b within the second opening 122b. The first sensor assembly 170 and the second sensor assembly 172 independently sense the movement, such as angular movement, of the first protrusion 144a and the second protrusion 144b, respectively and output signals indicative of the movement, position, and/or the like, to an electronic control unit either of the example pedal assembly or on the vehicle side, or both.

Referring back to FIGS. 1-3 and to FIGS. 5A-5B, the example pedal assembly 100 may further include the emulator assembly 110 for providing a pedal effort force and for biasing the pedal arm 106 to the home position along force, depicted by arrow 290, as best illustrated in FIG. 1. The emulator assembly 110 may include at least one biasing member, depicted as a pair of biasing members 288a, 288b positioned to extend between the receiving cavity 120 of the housing 104 and the pedal arm receiving cavity 154 of the pedal arm 106 and a damper 160. The damper 160 may include a pair of elongated members 161a and a cross beam 161b extending between the pair of elongated members 161a. The damper 160 may be partially positioned within the pedal arm receiving cavity 154 and extend from the innermost surface 142a in a direction away from the surface 142b. Each of the pair of elongated members 161a may be positioned adjacent to the continuous wall surface 156 and have an inner diameter D1, which is less than an inner diameter D2 of the biasing member 288a, as discussed in greater detail herein, such that the damper may be received within the biasing member 288a of the emulator assembly 110, as discussed in greater detail herein.

The emulator assembly 110 may be configured to provide a biasing force, depicted by arrow 290 provided via at least one of the biasing members 288a, 288b against the depression travel arc 292 when the force 294 is applied at the pedal pad 141 at the pedal pad end 140a.

In some embodiments, the at least one biasing member is depicted as the pair of biasing members 288a, 288b may be formed of any material that may be configured to exhibit a bias towards returning to an original pre-stressed shape, such as, but not limited to, a spring, rubber, silicone, or any other elastic and compressible material or configuration known in the art. Accordingly, each of the pair of biasing members 288a, 288b may operate to simulate a fluid system, such as a hydraulic system, that is based on a speed system. That is, the faster an operator depresses onto the pedal pad 141 of the pedal arm 106, the harder or more difficult the pedal arm 106 is to depress or further pivot, commonly known as a pedal effort force.

In at least one embodiment, the pair of biasing members 288a, 288b may be coaxially aligned such that the biasing member 288b may have a smaller outer diameter D3 than an inner diameter D2 of the biasing member 288a, whereby the biasing member 288b is at least partially nested within the biasing member 288b. As such, the pair of biasing members 288a, 288b may be a redundant biasing system.

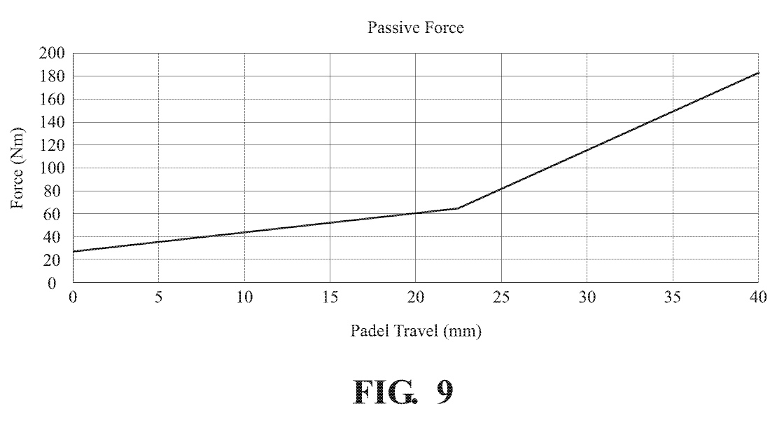

FIG. 9 graphically depicts a passive force of based on pedal travel in view of the emulator assembly 110 (FIG. 3). As depicted, the graphic is a force versus pedal travel to show the relationship between the amount of travel of the pedal arm 106 (FIG. 3) based on the load applied.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

It is also noted that recitations herein of “at least one” component, element, etc., should not be used to create an inference that the alternative use of the articles “a” or “an” should be limited to a single component, element, etc.

It is noted that recitations herein of a component of the present disclosure being "configured" or “programmed” in a particular way, to embody a particular property, or to function in a particular manner, are structural recitations, as opposed to recitations of intended use.

It is noted that one or more of the following claims utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

### Aspects Listing

Aspect 1. A pedal assembly including a housing having a first opening surrounded by a first recess portion, and a second opening surrounded by a second recess portion, a pedal arm having a pedal pad end and an opposite pivot end, a first protrusion extending from one side of the pivot end to be movably received within the first opening, and a second protrusion extending from the opposite side of the pivot end to be movably received within the second opening, a first sensor assembly configured to slidably engage with the first recess portion to retain the first protrusion in the first opening and a second sensor assembly configured to slidably engage with the second recess portion to retain the second protrusion in the second opening, wherein when a load is applied on the pedal pad end, the first protrusion moves within the first opening and the second protrusion moves within the second opening, the first sensor assembly and the second sensor assembly independently sense the movement of the first protrusion and the second protrusion, respectively.

Aspect 2. The pedal assembly of Aspect 1, wherein the first sensor assembly is configured as a Hall Effect sensor to sense the movement of the first protrusion.

Aspect 3. The pedal assembly of any of Aspect 1 to Aspect 2, further including a target, and a target carrier member configured to retain the target such that the target moves with the first protrusion, and wherein the Hall Effect sensor is configured to sense the movement of the target.

Aspect 4. The pedal assembly of any of Aspect 1 to Aspect 3, wherein the first protrusion includes a plurality of spaced apart receiving slots, the target carrier member having a plurality of spaced apart protrusions that correspond to the plurality of spaced apart receiving slots, and wherein each of the plurality of spaced apart receiving slots are configured to receive a respective one of the plurality of spaced apart protrusions to moveably couple the first protrusion to the target carrier member.

Aspect 5. The pedal assembly of any of Aspect 1 to Aspect 4, wherein the target carrier member is configured to couple to the first sensor assembly.

Aspect 6. The pedal assembly of any of Aspect 1 to Aspect 5, wherein the second sensor assembly is configured as an inductive sensor to sense the movement of the second protrusion.

Aspect 7. The pedal assembly of any of Aspect 1 to Aspect 6 further including a coupler and a coupler carrier member coupled to the second protrusion such that the coupler moves with the second protrusion, and wherein the inductive sensor is configured to sense the movement of the coupler.

Aspect 8. The pedal assembly of any of Aspect 1 to Aspect 7, wherein the second protrusion includes a plurality of spaced apart receiving slots, the coupler carrier member has a plurality of spaced apart protrusions that correspond to the plurality of spaced apart receiving slots, wherein each of the plurality of spaced apart receiving slots are configured to receive a respective one of the plurality of spaced apart protrusions to moveably couple the second protrusion to the coupler carrier member.

Aspect 9. The pedal assembly of any of Aspect 1 to Aspect 8, wherein the coupler carrier member is configured to couple to the second sensor assembly.

Aspect 10. The pedal assembly of any of Aspect 1 to Aspect 9 wherein the coupler carrier member further includes a carrier retaining portion spaced apart from a second target portion by an elongated arm portion, wherein the second target portion includes a second target that is sensed by the second sensor assembly.

Aspect 11. The pedal assembly of any of Aspect 1 to Aspect 10 wherein the second target is configured to move in response to movement by the second protrusion of the pedal arm, wherein the movement of the second target either transmits a first signal or stops the transmitting of a second signal indictive of movement of the pedal arm.

Aspect 12. The pedal assembly of any of Aspect 1 to Aspect 11 wherein the first recess portion includes at least one first receiving groove configured to receive an inner surface of the first sensor assembly, and the second recess portion includes at least one second receiving groove configured to receive an inner surface of the second sensor assembly.

Aspect 13. The pedal assembly of any of Aspect 1 to Aspect 12 further including an emulator assembly coupled to the pedal arm, the emulator assembly configured to provide a pedal effort force against a depression travel arc of the pedal arm as the load is applied at the pedal pad end.

Aspect 14. The pedal assembly of any of Aspects 1-13.

Aspect 15. An assembly including a housing having a first opening surrounded by a first recess portion, and a second opening surrounded by a second recess portion, a pedal arm having a pedal pad end and an opposite pivot end, a first protrusion extending from one side of the pivot end to be movably received within the first opening, and a second protrusion extending from the opposite side of the pivot end to be movably received within the second opening, a first sensor assembly configured to slidably engage with the first recess portion to retain the first protrusion in the first opening, the first sensor assembly including: a target, a target carrier member configured to retain the target such that the target moves with the first protrusion, and wherein the first sensor assembly is configured to sense the movement of the target, and a second sensor assembly configured to slidably engage with the second recess portion to retain the second protrusion in the second opening, the second sensor assembly including: a coupler, and a coupler carrier member coupled to the second protrusion such that the coupler moves with the second protrusion, and wherein the second sensor assembly is configured to sense the movement of the coupler, wherein when a load is applied on the pedal pad end, the first protrusion moves within the first opening and the second protrusion moves within the second opening, the first sensor assembly and the second sensor assembly independently sense the movement of the first protrusion and the second protrusion, respectively.

Aspect 16. The assembly of Aspect 15, wherein the first sensor assembly is configured as a Hall Effect sensor to sense the movement of the first protrusion and the second sensor assembly is configured as an inductive sensor to sense the movement of the second protrusion.

Aspect 17. The assembly of any of Aspect 15 to Aspect 16, wherein the first protrusion includes a plurality of spaced apart receiving slots, the target carrier member having a plurality of spaced apart protrusions that correspond to the plurality of spaced apart receiving slots, wherein each of the plurality of spaced apart receiving slots are configured to receive a respective one of the plurality of spaced apart protrusions to moveably couple the first protrusion to the target carrier member.

Aspect 18. The assembly of any of Aspect 15 to Aspect 17, wherein the second protrusion includes a plurality of spaced apart receiving slots, the coupler carrier member having a plurality of spaced apart protrusions that correspond to the plurality of spaced apart receiving slots, wherein each of the plurality of spaced apart receiving slots are configured to receive a respective one of the plurality of spaced apart protrusions to moveably couple the second protrusion to the coupler carrier member.

Aspect 19. The assembly of any of Aspect 15 to Aspect 18, wherein the target carrier member is configured to couple to the first sensor assembly and the coupler carrier member is configured to couple to the second sensor assembly.

Aspect 20. The assembly of any of Aspect 15 to Aspect 19, wherein the coupler carrier member further includes a carrier retaining portion spaced apart from a second target portion by an elongated arm portion, the second target portion includes a second target that is sensed by the second sensor assembly, and the second target configured to move in response to movement by the second protrusion of the pedal arm, wherein the movement of the second target either transmits a first signal or stops the transmitting of a second signal indictive of movement of the pedal arm.

Aspect 21. The assembly of any of Aspect 15 to Aspect 20, wherein the first recess portion includes at least one first receiving groove configured to receive an inner surface of the first sensor assembly and the second recess portion includes at least one second receiving groove configured to receive an inner surface of the second sensor assembly.

Aspect 22. The assembly of any of Aspects 1-21.

Aspect 23. A method including implementation of any combination of features of Aspects 1-21.

1. A pedal assembly comprising:
a housing having:
a first opening surrounded by a first recess portion, and
a second opening surrounded by a second recess portion,
a pedal arm having a pedal pad end and an opposite pivot end, a first protrusion extending from one side of the pivot end to be movably received within the first opening, and a second protrusion extending from the opposite side of the pivot end to be movably received within the second opening;
a first sensor assembly configured to slidably engage with the first recess portion to retain the first protrusion in the first opening; and
a second sensor assembly configured to slidably engage with the second recess portion to retain the second protrusion in the second opening,
wherein when a load is applied on the pedal pad end, the first protrusion moves within the first opening and the second protrusion moves within the second opening, the first sensor assembly and the second sensor assembly independently sense the movement of the first protrusion and the second protrusion, respectively.

2. The pedal assembly of claim 1, wherein the first sensor assembly is configured as a Hall Effect sensor to sense the movement of the first protrusion.

3. The pedal assembly of claim 2, further comprising:
a target; and
a target carrier member configured to retain the target such that the target moves with the first protrusion, and wherein the Hall Effect sensor is configured to sense the movement of the target.

4. The pedal assembly of claim 3, wherein:
the first protrusion includes a plurality of spaced apart receiving slots;
the target carrier member having a plurality of spaced apart protrusions that correspond to the plurality of spaced apart receiving slots,
wherein each of the plurality of spaced apart receiving slots are configured to receive a respective one of the plurality of spaced apart protrusions to moveably couple the first protrusion to the target carrier member.

5. The pedal assembly of claim 4, wherein the target carrier member is configured to couple to the first sensor assembly.

6. The pedal assembly of claim 1, wherein the second sensor assembly is configured as an inductive sensor to sense the movement of the second protrusion.

7. The pedal assembly of claim 6, further comprising:
a coupler; and
a coupler carrier member coupled to the second protrusion such that the coupler moves with the second protrusion, and wherein the inductive sensor is configured to sense the movement of the coupler.

8. The pedal assembly of claim 7, wherein:
the second protrusion includes a plurality of spaced apart receiving slots; and
the coupler carrier member having a plurality of spaced apart protrusions that correspond to the plurality of spaced apart receiving slots,
wherein each of the plurality of spaced apart receiving slots are configured to receive a respective one of the plurality of spaced apart protrusions to moveably couple the second protrusion to the coupler carrier member.

9. The pedal assembly of claim 8, wherein the coupler carrier member is configured to couple to the second sensor assembly.

10. The pedal assembly of claim 8, wherein the coupler carrier member further comprises:
a carrier retaining portion spaced apart from a second target portion by an elongated arm portion,
wherein the second target portion includes a second target that is sensed by the second sensor assembly.

11. The pedal assembly of claim 10, wherein:
the second target is configured to move in response to movement by the second protrusion of the pedal arm,
wherein the movement of the second target either transmits a first signal or stops the transmitting of a second signal indictive of movement of the pedal arm.

12. The pedal assembly of claim 1, wherein:
the first recess portion includes at least one first receiving groove configured to receive an inner surface of the first sensor assembly; and
the second recess portion includes at least one second receiving groove configured to receive an inner surface of the second sensor assembly.

13. The pedal assembly of claim 1, further comprising:
an emulator assembly coupled to the pedal arm, the emulator assembly configured to provide a pedal effort force against a depression travel arc of the pedal arm as the load is applied at the pedal pad end.

14. An assembly comprising:
a housing having:
a first opening surrounded by a first recess portion, and
a second opening surrounded by a second recess portion,
a pedal arm having a pedal pad end and an opposite pivot end, a first protrusion extending from one side of the pivot end to be movably received within the first opening, and a second protrusion extending from the opposite side of the pivot end to be movably received within the second opening;
a first sensor assembly configured to slidably engage with the first recess portion to retain the first protrusion in the first opening, the first sensor assembly including:
a target,
a target carrier member configured to retain the target such that the target moves with the first protrusion, and wherein the first sensor assembly is configured to sense the movement of the target, and
a second sensor assembly configured to slidably engage with the second recess portion to retain the second protrusion in the second opening, the second sensor assembly including:
a coupler, and
a coupler carrier member coupled to the second protrusion such that the coupler moves with the second protrusion, and wherein the second sensor assembly is configured to sense the movement of the coupler,
wherein when a load is applied on the pedal pad end, the first protrusion moves within the first opening and the second protrusion moves within the second opening, the first sensor assembly and the second sensor assembly independently sense the movement of the first protrusion and the second protrusion, respectively.

15. The assembly of claim 14, wherein:
the first sensor assembly is configured as a Hall Effect sensor to sense the movement of the first protrusion; and
the second sensor assembly is configured as an inductive sensor to sense the movement of the second protrusion.

16. The assembly of claim 14, wherein:
the first protrusion includes a plurality of spaced apart receiving slots; and
the target carrier member having a plurality of spaced apart protrusions that correspond to the plurality of spaced apart receiving slots,
wherein each of the plurality of spaced apart receiving slots are configured to receive a respective one of the plurality of spaced apart protrusions to moveably couple the first protrusion to the target carrier member.

17. The assembly of claim 14, wherein:
the second protrusion includes a plurality of spaced apart receiving slots; and
the coupler carrier member having a plurality of spaced apart protrusions that correspond to the plurality of spaced apart receiving slots,
wherein each of the plurality of spaced apart receiving slots are configured to receive a respective one of the plurality of spaced apart protrusions to moveably couple the second protrusion to the coupler carrier member.

18. The assembly of claim 14, wherein:
the target carrier member is configured to couple to the first sensor assembly; and
the coupler carrier member is configured to couple to the second sensor assembly.

19. The assembly of claim 14, wherein the coupler carrier member further comprises:
a carrier retaining portion spaced apart from a second target portion by an elongated arm portion, the second target portion includes a second target that is sensed by the second sensor assembly, and the second target configured to move in response to movement by the second protrusion of the pedal arm,
wherein the movement of the second target either transmits a first signal or stops the transmitting of a second signal indictive of movement of the pedal arm.

20. The assembly of claim 14, wherein:
the first recess portion includes at least one first receiving groove configured to receive an inner surface of the first sensor assembly; and
the second recess portion includes at least one second receiving groove configured to receive an inner surface of the second sensor assembly.
